(19) United States
(12) Patent Application Publication
(10) Pub. No.: US 2006/0213059 A1
(43) Pub. Date: Sep. 28, 2006

(54) Hex tool

(76) Inventor: Robert Eggert, Hamilton, NJ (US)

Correspondence Address: Arthur M. Peslak, Esq.;MANDEL & PESLAK, LLC, Suite 5, 80 Scenic Drive, Freehold, NJ, 07728, US

(21) Appl. No.: 11/089,307

(22) Filed: Mar. 23, 2005

(51) Int. Cl. H01R 43/00; H01B 13/20; B23P 19/00

(52) U.S. Cl. 29/857; 29/828; 29/750

(57) ABSTRACT

What is disclosed is a tool adapted to facilitate the installation of coaxial cables such as on a television, cable television box, or satellite box. The tool is generally cylindrical in shape and is adapted to receive the coaxial cable and a hexagonal nut on its distal end.

### BACKROUND OF THE INVENTION

The present invention is directed to a tool adapted to facilitate the installation of coaxial cables and various nuts and adaptors used therewith. Coaxial cables are typically used for the provision of cable or satellite television in the home. The fittings on the end of coaxial cables are threaded onto a mating port on a television or cable television box. It is somewhat difficult to install these fittings with conventional hand tools, such as available wrenches. Thus, the present invention is directed to a tool that facilitates easy installation of such cables.

### BRIEF DESCRIPTION OF THE DRAWINGS

FIG. 1 is a plan view of one embodiment of the present invention.

FIG. 2 is plan view of an alternate embodiment of the present invention.

FIG. 3 is a plan view of an alternate embodiment of the present invention.

FIG. 4 is a side view of the embodiment illustrated in FIG. 3.

FIG. 5 illustrates the use of the embodiment shown in FIG. 1.

FIG. 6 illustrates the use of the embodiment shown in FIG. 2.

### DETAILED DESCRIPTION OF THE INVENTION

The present invention will now be described in terms of the presently preferred embodiment thereof. Those of ordinary skill in the art will recognize that many obvious changes may be made thereto without departing from the spirit or scope of the present invention.

Coaxial cables are typically used to provide cable or satellite television service into a house. The coaxial cables generally are provided with what is referred to as an f-type connector on the end of the cable. The f-type connector comprises a hexagonal nut on its end for connecting to a cable or satellite television base. Due to the tight spaces in which such connectors are normally used, it is difficult to easily thread the connector to the back of the device.

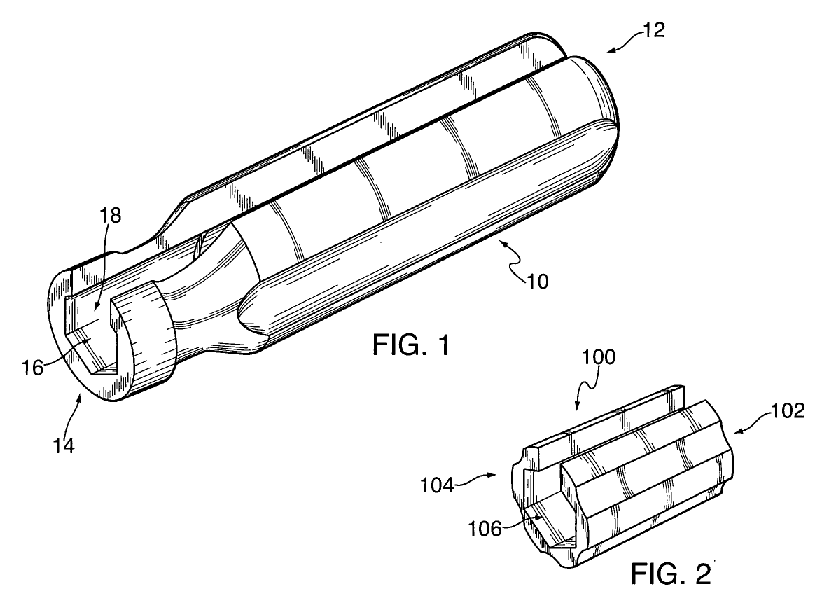

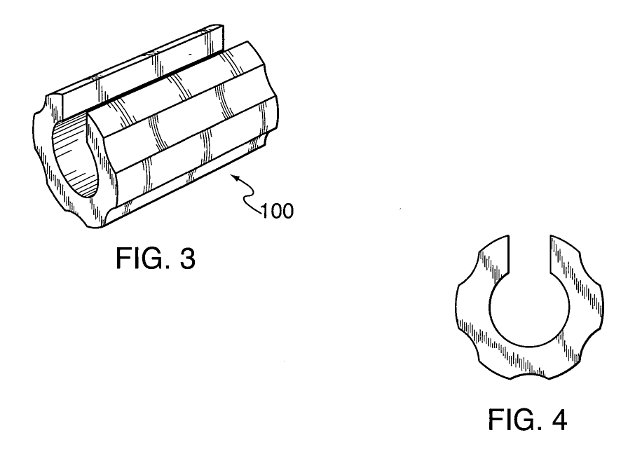

The first embodiment of the present invention is as shown in FIG. 1. The tool 10 is similar to a conventional handle for a screwdriver. The tool 10 comprises a proximal end 12 and a distal end 14. An axial through hole 16 is provided in the center of the tool 10 running from the distal end 14 to the proximal end 12. The distal end 14 is provided with a hexagonal cutout 18.

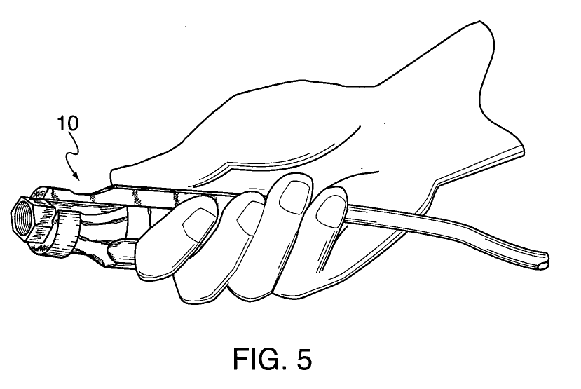

The use of the tool 10 is illustrated in FIG. 5. The tool 10 as illustrated in FIG. 1 is placed over a coaxial cable 20. The coaxial cable 20 is received in the through hole 16. An f-connector 22 is provided on the end of the coaxial cable 20. The f-connector 22 is received in the hexagonal cutout 18 at the distal end 14. After being placed into the tool 10, the f-connector 22 is placed into contact with a mating connector 20 on a television or cable box. The user then rotates the tool 10 which easily threads the f-connector 22 onto the mating connector. The tool 10 is then easily removed from the f-connector.

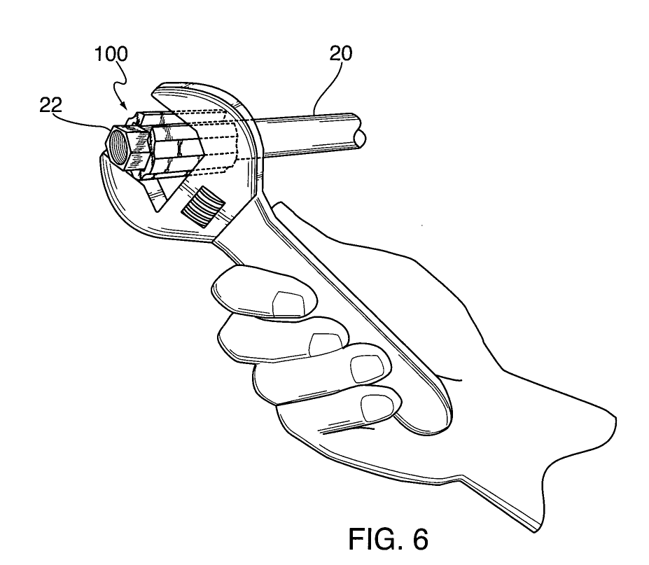

An alternate embodiment of the present invention is illustrated in FIGS. 2,3, and 4. In this embodiment, the tool 100 is of a smaller length than the previous embodiment. The tool 100 comprises a proximal end 102 and a distal end 104. The tool 100 further comprises an axial through hole 106. The axial through hole is adjusted on its distal end 104 to fit onto the hexagonal nut on an f-connector. The end of the tool 100 is illustrated in FIG. 6. In this embodiment, the tool is used in a similar fashion as the previous embodiment 10.

The tools 10 or 100 of the present invention can also be used to facilitate the installation of the f-connector 22 onto the coaxial cable 20. The tools 10 and 100 are adjusted to fit onto the hexagonal nut on the f-connector 22. Thus, the tools can be used in place of the f-connector 22 onto the coaxial cable 20 in a similar manner.

Those of ordinary skill in the art will recognize that the foregoing embodiments merely illustrate the principals of the present invention and that many obvious modifications may be made thereto without departing form the spirit or scope of the present invention as set forth in the appended claims.

What is claimed is:

1. A tool for facilitating the installation of coaxial cables onto a device comprising:
a) a generally cylindrical shaft comprising a distal end, a proximal end, and a longitudinal axis from the distal end to the proximal end;
b) a through hole generally parallel to the longitudinal axis from the proximal end to the distal end adapted to receive a coaxial cable; and
c) a fitting on the distal end adapted to receive a hexagonal nut on the end of the coaxial cable.

2. A method for installing a coaxial cable onto a device comprising the steps of:
a) providing a tool comprising a generally cylindrical shaft comprising a distal, proximal end, and a longitudinal axis, a through hole generally parallel to the axis from the distal end to the proximal and a fitting in the distal end adjusted to receive a hexagonal nut;
b) placing a coaxial cable with a f-connector into the through hole;
c) placing a hexagonal nut on the f-connector into the fitting;
d) placing the f-connector into contact with a mating connector on the device;
e) using the tool to rotate the f-connector and thereby connect the coaxial cable to the device.
